(19) United States
(12) Patent Application Publication
(10) Pub. No.: US 2015/0058717 A1
(43) Pub. Date: Feb. 26, 2015

(54) Document Editing Apparatus, Non-Transitory Computer-Readable Recording Medium and Document Editing Method

(71) Applicant: Konica Minolta, Inc., Tokyo (JP)

(72) Inventors: Yoshinori TANAKA, Tokyo (JP); Kazuhisa Kishimoto, Tokyo (JP); Yasuyuki Kamai, Tokyo (JP)

(21) Appl. No.: 14/462,394

(22) Filed: Aug. 18, 2014

(30) Foreign Application Priority Data
Aug. 20, 2013 (JP) 2013-170525

(51) Int. Cl. G06F 17/24; G06F 3/0483

(52) U.S. Cl. CPC G06F 17/24; G06F 3/0483
USPC 715/256

(57) ABSTRACT

Disclosed is a document editing apparatus including: a display unit; a page changing unit; an operating unit; an editing unit; an undo and redo memory; an undo and redo instruction unit; a memory management unit to manage an upper limit of number of storable editing history data including the editing history data of the editing operation performed in the displayed part; and an undo and redo performance unit to perform the undo operation by tracing back only the editing history data of the editing operation performed in the part displayed when the instruction to perform the undo operation is received, and to perform the redo operation by tracing back only the editing history data of the editing operation performed in the part displayed when the instruction to perform the redo operation is received.

### BACKGROUND OF THE INVENTION

1. Field of the Invention

The present invention relates to a document editing apparatus having undo and redo functions, a non-transitory computer-readable recording medium and a document editing method.

2. Description of Related Art

Most of document editing apparatuses have a function of storing editing history data of editing operations received from a user, undoing previously-performed editing operations in order from the newest editing operation by tracing back in time sequence, and redoing the undone editing operations (canceling an undo operation).

Normally, a document editing apparatus has an undo button and a redo button, and when the undo button is operated once, the newest editing operation is canceled and the editing state is returned to a previous state. Further, when the undo button is repeatedly operated, the editing operations are continuously canceled so as to trace back in time sequence. Likewise, when the redo button is pressed down, the editing operation canceled by the newest undo operation is performed again. Further, when the redo button is continuously operated, a plurality of the editing operations canceled by the undo operation are performed again in the reverse order which is reverse to the order of the undo operation, and the editing state can be returned to a state before the cancel of the editing operations.

Japanese Patent Application Publication No. 2010-515516 discloses an undo and redo system capable of specifying a given past time by using a slider bar or the like and returning to editing contents at the specified time for the purpose of saving time and effort for repeating an operation of the undo button or the like.

Further, there is a problem that in general, when characters are deleted or added by the undo operation and then a new input is performed, the characters deleted or added by the undo operation cannot be restored any more. As a technology for dealing with the above-described problem, Japanese Patent Application Publication No. 2008-257318 discloses a technology capable of additionally recording the undo operation itself also as new editing history data of an editing operation, and restoring a character input state at a given past time by tracing back to the additional record in order.

In case that a document having a plurality of pages is edited, when an editing operation such as addition or deletion of characters is performed in a certain page, a user is sometimes aware of an error in editing contents of another page in which editing operations have been performed. At this time, when the undo function is used in order to correct the error, the editing operations are canceled in order by tracing back from the current time in time sequence. Accordingly, before the editing operation in a target page is undone, the editing operation performed in the current page also is canceled.

Further, in case that the editing operation is performed while the page is changed, when the undo operation is repeated in order to cancel the editing operation performed in the page which is currently displayed, by tracing back to a predetermined past operation, the page which is currently displayed is changed to the page which was previously displayed. Then, the editing operation performed in the page which was previously displayed is canceled.

Even if the technologies disclosed in Japanese Patent Application Publications Nos. 2010-515516 and 2008-257318 are used, the above-described problem is not solved.

Further, in order to solve the above-described problem, it is preferable to effectively use the undo and redo memories so as not to increase the capacity of the memory used for the undo and redo operations.

### SUMMARY

To achieve at least one of the abovementioned objects, a document editing apparatus reflecting one aspect of the present invention comprises:

a display unit configured to display a part of a document;

a page changing unit configured to change one or more pages displayed on the display unit;

an operating unit configured to receive an editing operation performed in the part displayed on the display unit;

an editing unit configured to edit the part displayed on the display unit in accordance with the editing operation received by the operating unit;

an undo and redo memory configured to store editing history data of the editing operation performed by the editing unit;

an undo and redo instruction unit configured to receive an instruction to perform an undo operation or a redo operation for the editing operation performed by the editing unit;

a memory management unit configured to manage an upper limit of number of storable editing history data including the editing history data of the editing operation performed in the part displayed on the display unit, in units of the document, in units of the part displayed on the display unit or in units of the undo and redo memory; and

an undo and redo performance unit configured to perform the undo operation by tracing back only the editing history data of the editing operation performed in the part displayed on the display unit when the instruction to perform the undo operation is received, among the editing history data stored in the undo and redo memory, in case that the undo and redo instruction unit receives the instruction to perform the undo operation; and configured to perform the redo operation by tracing back only the editing history data of the editing operation performed in the part displayed on the display unit when the instruction to perform the redo operation is received, among the editing history data stored in the undo and redo memory, in case that the undo and redo instruction unit receives the instruction to perform the redo operation.

Preferably, in case that the upper limit is managed in units of the displayed part, the memory management unit manages the upper limit of the number of the storable editing history data for a page which is not displayed on the display unit, in units of the page, and the upper limit to be set for the displayed part is set within a sum of the upper limit set for each of one or more pages in the displayed part.

Preferably, in case that the upper limit is managed in units of the displayed part, when at least one of the pages displayed on the display unit is not displayed on the display unit by changing at least one of the pages, the memory management unit deletes the editing history data by excess of the editing history data over the upper limit set for the page which is not displayed on the display unit by changing one of the pages,

wherein the excess is caused in case that the number of the stored editing history data for the page which is not displayed on the display unit by changing one of the pages exceeds the upper limit set for the page which is not displayed on the display unit by changing one of the pages.

Preferably, in case that the upper limit is managed in units of the document or in units of the undo and redo memory, the memory management unit extracts only the editing history data of the editing operation performed in the part displayed on the display unit from the undo and redo memory and prepares a display undo/redo buffer for registering the extracted editing history data,

when the editing operation is performed by the editing unit in the part displayed on the display unit, the memory management unit registers the editing history data of the performed editing operation in the display undo/redo buffer,

the undo and redo performance unit performs the undo operation and the redo operation by tracing back the editing history data registered in the display undo/redo buffer, and

when at least one of the pages displayed on the display unit is not displayed on the display unit by changing at least one of the pages, the memory management unit reflects the editing history data registered in the display undo/redo buffer on the undo and redo memory immediately before the page is changed.

Preferably, in case that the number of the stored editing history data exceeds the managed upper limit, the memory management unit preferentially deletes the editing history data having old entry time and date.

Preferably, the memory management unit indicates the editing history data of the editing operation to be undone in case that a next instruction to perform the undo operation is received, by a pointer for each page.

Preferably, the editing operation includes a handwriting input.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a plan view showing a document editing apparatus according to the embodiment;

FIG. 2 is a block diagram showing an electric schematic configuration of the document editing apparatus;

FIG. 3 is a view showing an example of a document unit undo/redo buffer used in a document unit method;

FIG. 4 is a view showing an example of a display undo/redo buffer constructed from the document unit undo/redo buffer in case that only one page is displayed;

FIG. 5 is a plan view showing the document editing apparatus in the state in which a plurality of pages are reduced and simultaneously displayed;

FIG. 6 is a view showing an example of the display undo/redo buffer constructed from the document unit undo/redo buffer in case that a plurality of pages are simultaneously displayed;

FIG. 7 is a flowchart showing the process relating to the undo operation and the redo operation in the document unit method;

FIG. 8 is a view showing the display undo/redo buffer constructed when a plurality of pages are simultaneously displayed, and the like in a page unit method;

FIG. 9 is a view showing the situation in which a plurality of the page unit undo/redo buffers are reconstructed from the display undo/redo buffer in the page unit method; and

FIG. 10 is a flowchart showing the process relating to the undo operation and the redo operation in the page unit method.

### DETAILED DESCRIPTION OF PREFERRED EMBODIMENT

Hereinafter, a preferred embodiment of the present invention will be explained with reference to the accompanying drawings.

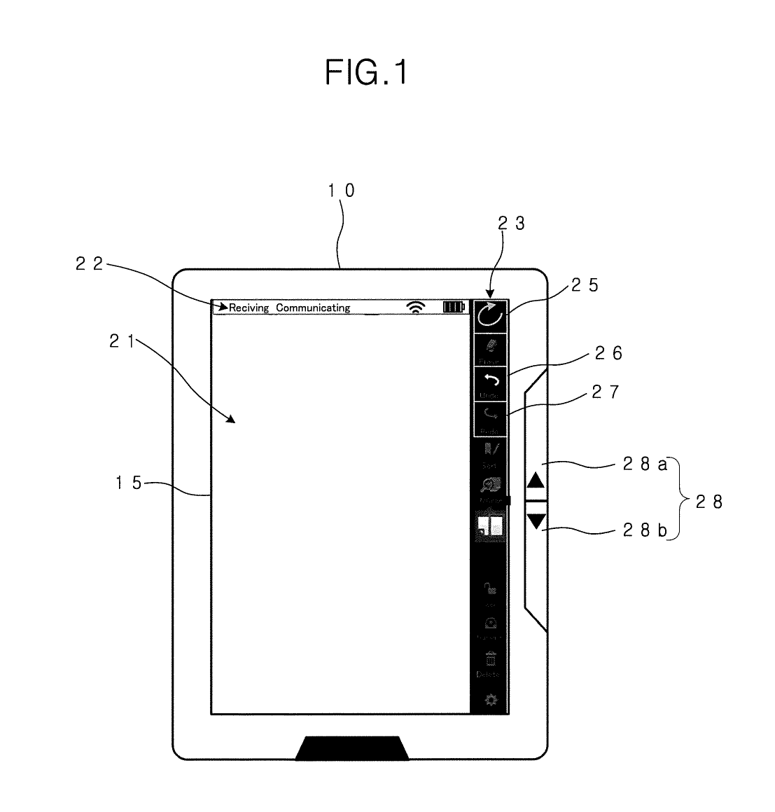

FIG. 1 is a plan view showing the document editing apparatus 10 according to the embodiment. The document editing apparatus 10 can wirelessly communicate with an external device which is, for example, an information processing apparatus, such as a personal computer or the like via a network such as a wireless LAN. Further, the document editing apparatus 10 has a function of receiving document data from the information processing apparatus and the like, displaying and editing the document, and adding a handwritten memo. Further, the document editing apparatus 10 has a function of transmitting a document which has been edited by adding the handwritten memo, to an external device such as the information processing apparatus or a printer. The document editing apparatus 10 is used for, for example, the revision, the correction, and the like of the documents to be printed.

The document editing apparatus 10 is a portable terminal having a plate shape of an approximate A4 size, and nearly the whole area of the surface thereof is a display surface of a display unit 15. The display unit 15 is a display device which can hold display contents without consumption of power, and which consumes the power when the display contents are rewritten. For example, the display unit 15 is configured by the electrophoretic type of electronic paper.

Further, on the display surface of the display unit 15, a touch panel which detects a position on which the display surface is touched by a finger, a pen, or the like is provided. On the display surface of the display unit 15 of the document editing apparatus 10, a page display area 21 in which the rewriting of the display contents is performed by an operation of a user, a system information area 22 in which the document editing apparatus 10 automatically updates the display contents, and a tool bar 23 are displayed. The system information area 22 is provided on the upper part of the display surface of the display unit 15, and the tool bar 23 is provided in a vertical band shape on the right edge of the display surface of the display unit 15. The entire display surface of the display unit 15 except the system information area 22 and the tool bar 23 is the page display area 21.

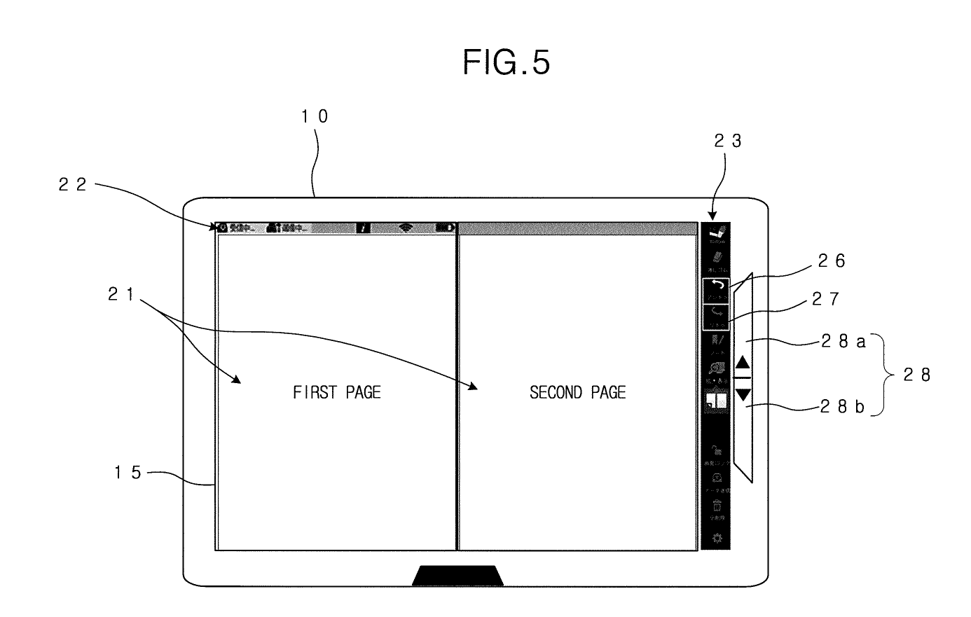

On the page display area 21, a document or an image to be browsed or edited is displayed page by page, or a plurality of pages are reduced and simultaneously displayed as shown in FIG. 5. That is, the page display area 21 of the display unit 15 displays a part of a document (one or a plurality of pages). Further, the user can add characters or figures in handwriting to the page display area 21.

On the system information area 22, information such as the time, the date, the radio field intensity of wireless communication, the battery residual capacity, and the like is displayed. The display contents of the system information area 22 are automatically updated by the document editing apparatus 10.

On the tool bar 23, a button for selecting various tools (a pen, a rubber eraser, and the like) for the handwriting input, an undo button 26, a redo button 27, and the like are displayed. The undo button 26 is an operation button for inputting an instruction to perform an undo operation once. The redo button 27 is an operation button for inputting an instruction to perform a redo operation once. The undo button 26 and the redo button 27 configure the undo and redo instruction unit which receives the instruction to perform the undo operation and the redo operation.

The undo operation is an operation for canceling a newest editing operation and returning to the editing state before the editing operation, and the redo operation is an operation for canceling a newest undo operation and returning to the editing state before the undo operation is performed. When the instruction to perform the undo operation is continued two or more times, a plurality of the editing operations are canceled in order by tracing back from the newest operation in time sequence without changing the displayed page to another page. When the undo operation is performed two or more times and then the redo operation is continued two or more times, a plurality of the undo operations are canceled in order by tracing back from the newest undo operation in time sequence.

In the front face of the document editing apparatus 10, on the frame part at the right side position of the display unit 15, a page turning button 28 which receives an operation for changing a page displayed on the page display area 21 of the display unit 15 to a previous page or a next page (page turning operation) from the user is provided. The page turning button 28 is configured by a next page button 28a for forwarding a page displayed on the page display area 21 to the next page and a previous page button 28b for returning the page to a previous page.

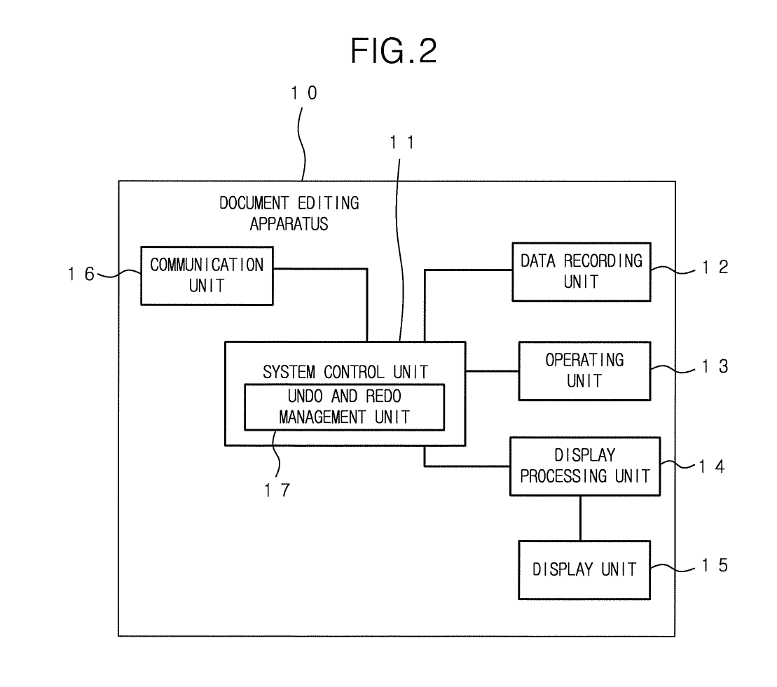

FIG. 2 shows an electric schematic configuration of the document editing apparatus 10. The document editing apparatus 10 comprises a system control unit 11 which totally controls the operations of the document editing apparatus 10, a data recording unit 12, an operating unit 13, a display processing unit 14, and a communication unit 16, which are connected to the system control unit 11. The display unit 15 is connected subordinately to the display processing unit 14.

The system control unit 11 mainly controls the entire system, such as the control of the transmission and the reception of data, the storage of data, the control of reading out data, the control of displaying documents on the display unit 15, and the control of the reception of various operations or handwriting input from the user. The system control unit 11 comprises a CPU (Central Processing Unit), a ROM (Read Only Memory), and a RAM (Random Access Memory) as a main part. Further, by executing a program stored in the ROM, the function of the document editing apparatus 10 can be realized. The RAM is used as a work memory for temporarily storing various data when the CPU executes a program.

The data recording unit 12 is a memory for storing data of documents or images to be displayed, the handwritten input data, the setting to be used in the system control, and the like. The data recording unit 12 is a nonvolatile memory. The data recording unit 21 is used as an undo and redo memory which is a storage area for storing editing history data of the editing operation performed in a document.

The operating unit 13 has a function of receiving operations from the user, and is configured by key switches and a touch panel. Specifically, the operating unit 13 includes each button of the above-described tool bar 23, the page turning button 28, and the like. Further, the operating unit 13 receives the editing operation performed in the document displayed on the display unit 15.

The display processing unit 14 controls the display unit 15 to rewrite the display contents in accordance with the instruction of the system control unit 11. The display unit 15 is the above-described electrophoretic type of electronic paper. The display unit 15 is a so-called dot matrix type of display device in which pixels are arrayed in lengthwise and crosswise directions in a matrix form.

The communication unit 16 has a function to transmit and receive data to/from the external device. For example, the communication unit 16 has a function to receive data to be displayed, such as documents or images, and transmit the documents which have been edited by the document editing apparatus 10 or the data indicating handwritten contents to the external device.

The system control unit 11 has a function as an undo and redo management unit 17. The undo and redo management unit 17 has a function to manage the undo and redo memory (the function as the memory management unit), a function to control the performance of the undo operation and the redo operation (the function as the undo and redo performance unit), and the like. Further, the system control unit 11 has a function as the editing unit which edits one or more pages displayed on the page display area 21 of the display unit 15 in accordance with the editing operation received by the operating unit 13, a function as the page changing unit which changes one or more pages displayed on the display unit 15, in accordance with a page turning operation received by the page turning button 28, and the like.

Next, the undo function and the redo function of the document editing apparatus 10 will be explained.

In case that the instruction to perform the undo operation is received, the system control unit 11 (the undo and redo management unit 17) of the document editing apparatus 10 performs the undo operation by tracing back only the editing history data of the editing operation performed in one or more pages (a displayed part of a document) displayed on the page display area 21 of the display unit 15 when the instruction to perform the undo operation is received, in time sequence among the editing history data stored in the data recording unit 12. On the other hand, in case that the instruction to perform the redo operation is received, the system control unit 11 (the undo and redo management unit 17) performs the redo operation by tracing back only the editing history data of the editing operation performed in one or more pages (the displayed part of the document) displayed on the page display area 21 of the display unit 15 when the instruction to perform the redo operation is received, in time sequence among the editing history data stored in the data recording unit 12.

For example, a first page is displayed and a first editing operation is performed in the first page, and then a second page is displayed and a second editing operation is performed in the second page. Then, the first page is displayed and a third editing operation is performed in the first page. Thereafter, when the undo operation is instructed, the third editing operation is firstly undone. Further, when the undo operation is instructed, the first editing operation is undone.

A method for managing the undo and redo memory in the document editing apparatus 10 includes a document unit method in which the upper limit of the number of times of the undo operation and the upper limit of the number of times of the redo operation are managed in units of the document, a page unit method in which the upper limit of the number of times of the undo operation and the upper limit of the number of times of the redo operation are managed in units of the page, and an apparatus unit method in which the upper limit of the number of times of the undo operation and the upper limit of the number of times of the redo operation are managed in units of the entire undo and redo memory. Hereinafter, each of the methods will be explained.

### <Document Unit Method>

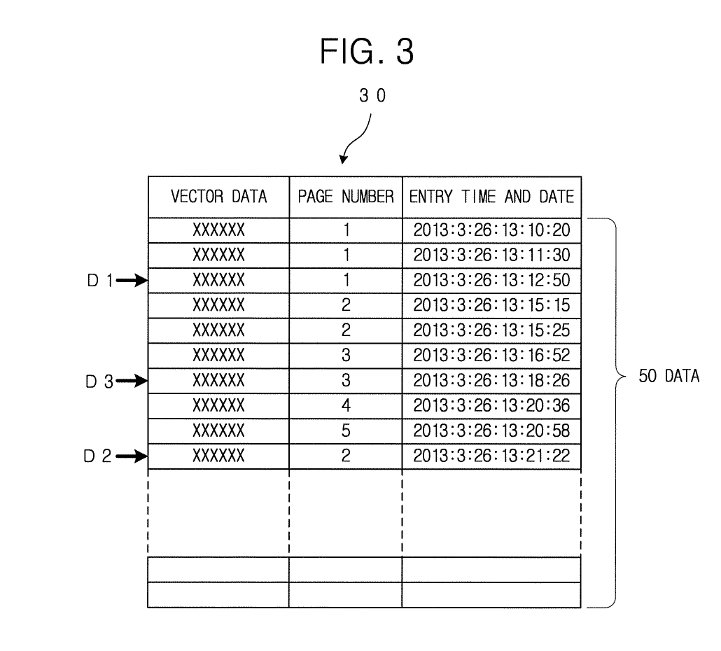

FIG. 3 shows an example of a document unit undo/redo buffer 30 used in the document unit method. A predetermined area in the undo and redo memory of the document editing apparatus 10 is allocated as the document unit undo/redo buffer 30 for one document. Further, in case that one document forms one file, the document unit is equivalent to the file unit.

In the document unit undo/redo buffer 30, the editing history data indicating the editing contents performed in accordance with the editing operation received from the user is stored. In the example of FIG. 3, the document unit undo/redo buffer 30 can store 50 editing history data. That is, the system control unit 11 (the undo and redo management unit 17) manages the upper limit of the number of the storable editing history data (the undo operation and the redo operation) in units of the document.

In this embodiment, it is assumed that the handwriting input is received as the editing operation. The contents of one editing history data stored in the document unit undo/redo buffer 30 include vector data indicating the contents of the handwriting input, the page number of the page in which the handwriting input is received, and the entry time and date indicating the time and date at which the handwriting input is received.

Further, the system control unit 11 (the undo and redo management unit 17) indicates the editing history data of the editing operation to be undone in case that the next instruction to perform the undo operation is received, by a pointer for each page. In FIG. 3, a pointer D1 for the first page, a pointer D2 for the second page, and a pointer D3 for the third page are shown as arrows indicating the editing history data of the editing operation to be undone when the instruction to perform the undo operation is received next, for each page.

In the embodiment, the case in which one page is displayed on the page display area 21 will be first explained.

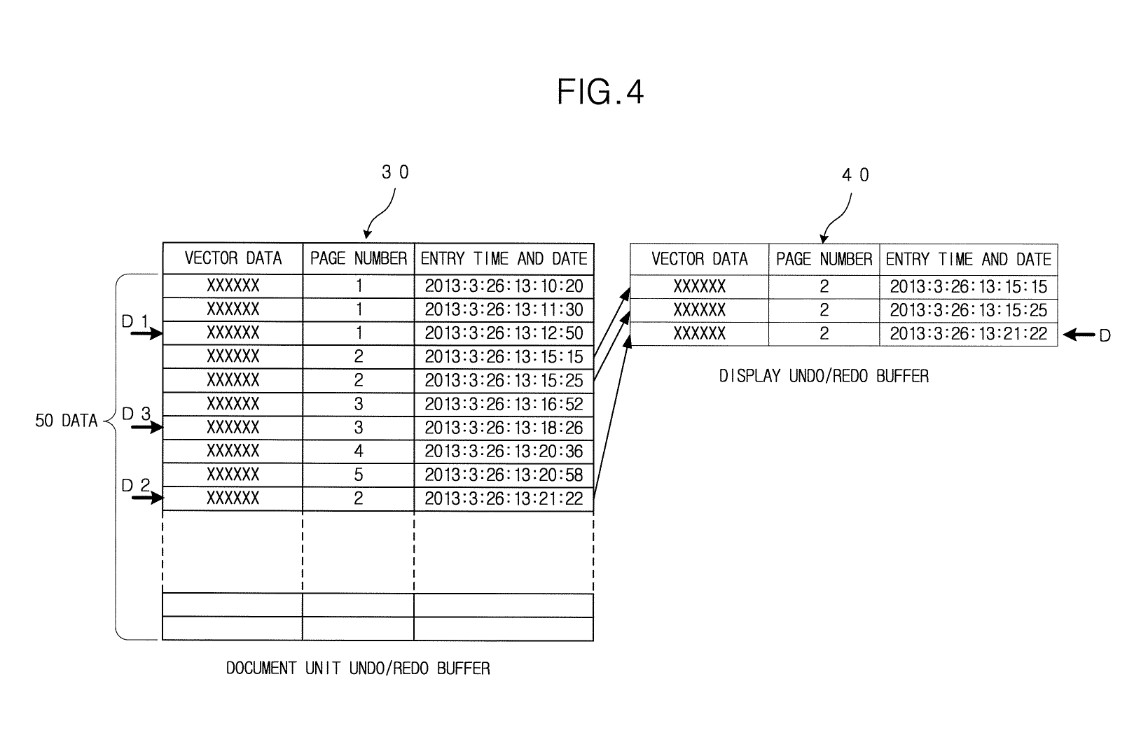

In the document unit method, the system control unit 11 (the undo and redo management unit 17) extracts only the editing history data of the editing operation performed in the page having the page number which is the same as that of the page which is currently displayed on the page display area 21 of the display unit 15 of the document editing apparatus 10, from the document unit undo/redo buffer 30. Further, the system control unit 11 constructs an undo/redo buffer relating to only the page which is currently displayed (referred to as the display undo/redo buffer 40, See FIG. 4).

A pointer for the display undo/redo buffer 40 is referred to as a display pointer D. When the display undo/redo buffer 40 is constructed, the system control unit 11 (the undo and redo management unit 17) sets an initial value of the display pointer D so as for the display pointer D to indicate the editing history data in the display undo/redo buffer 40, which is the same as the editing history data indicated by the pointer for the displayed page in the document unit undo/redo buffer 30.

When the instruction to perform the undo operation or the redo operation is received via the undo button 26 or the redo button 27, the document editing apparatus 10 performs the process relating to the undo operation or the redo operation by tracing back the editing history data stored in the display undo/redo buffer 40.

Specifically, when the instruction to perform the undo operation is received, the system control unit 11 (the undo and redo management unit 17) performs the undo operation in accordance with the editing history data indicated by the display pointer D in the display undo/redo buffer 40. At the same time, the system control unit 11 updates the display pointer D so as for the display pointer D to indicate the editing history data having the next older entry time and date in the display undo/redo buffer 40.

After the instruction to perform the undo operation is received, when the instruction to perform the redo operation is received, the system control unit 11 (the undo and redo management unit 17) performs the redo operation in accordance with the editing history data having the next newer entry time and date than the editing history data indicated by the display pointer D in the display undo/redo buffer 40, and updates the display pointer D so as to indicate the above editing history data having the next newer entry time and date.

Further, in case that the handwriting input (additional writing) is received from the user, the editing history data of the editing operation corresponding to the handwriting input is stored in the display undo/redo buffer 40. That is, when the editing operation is performed in the page displayed on the display unit 15, the system control unit 11 (the undo and redo management unit 17) registers the editing history data of the performed editing operation in the display undo/redo buffer 40. In more detail, firstly, the system control unit 11 (the undo and redo management unit 17) deletes the editing history data having the entry time and date which is newer than that of the editing history data indicated by the display pointer D, from the display undo/redo buffer 40. Then, the system control unit 11 (the undo and redo management unit 17) additionally stores the editing history data of the handwriting input in the display undo/redo buffer 40 so as to arrange the editing history data in the order of the entry time and date, and updates the display pointer D so as to indicate the added editing history data.

As described above, by performing the undo operation and the redo operation in accordance with the display undo/redo buffer 40, the displayed page is not changed. Then, the undo operation and the redo operation can be continuously performed in the displayed page.

In case that the operation for the page turning button 28 is received and the page displayed on the page display area 21 is changed, or in case that the document is closed and the editing operation is finished, the system control unit 11 (the undo and redo management unit 17) returns the editing history data stored in the display undo/redo buffer 40 to the document unit undo/redo buffer 30 and reconstructs the document unit undo/redo buffer 30. In the reconstruction, all the editing history data are set so as to arrange the editing history data in the order of the entry time and date in the document unit undo/redo buffer 30. That is, when the page displayed on the display unit 15 is not displayed on the display unit 15 by changing the page, the system control unit 11 (the undo and redo management unit 17) reflects the editing history data registered in the display undo/redo buffer 40 on the undo and redo memory (the document unit undo/redo buffer 30) immediately before the page is changed.

Further, in case that the free space of the document unit undo/redo buffer 30 is lack during the reconstruction, that is, in case that when the editing history data stored in the display undo/redo buffer 40 is returned to the document unit undo/redo buffer 30, a total number of the editing history data exceeds the upper limit of the number of times of the undo operation or the redo operation (in this example, 50) in the document unit undo/redo buffer 30, the system control unit 11 (the undo and redo management unit 17) deletes the editing history data in the order from the oldest entry time and date so as for the number of the editing history data stored in the document unit undo/redo buffer 30 not to exceed the above-described upper limit. Accordingly, the document unit undo/redo buffer 30 is a ring buffer.

Further, the system control unit 11 (the undo and redo management unit 17) updates the pointer for the page in which the undo operation and the redo operation are managed by the display undo/redo buffer 40, in the document unit undo/redo buffer 30, so as to indicate the editing history data which is the same as the editing history data which is finally indicated by the display pointer D.

FIG. 4 shows an example of the display undo/redo buffer 40 constructed from the document unit undo/redo buffer 30 in case that only the second page is displayed on the page display area 21.

The system control unit 11 (the undo and redo management unit 17) extracts only the editing history data having the page number of “2”, from the document unit undo/redo buffer 30, and arranges the extracted editing history data in the order of the entry time and date to construct the display undo/redo buffer 40.

Further, when the display undo/redo buffer 40 is constructed, the display pointer D is initialized so as to indicate the editing history data in the display undo/redo buffer 40, which is the same as the editing history data indicated by the pointer D2 for the second page in the document unit undo/redo buffer 30.

In the display undo/redo buffer 40 of FIG. 4, because the editing history data are arranged from above in the order of the old entry time and date, the initialized display pointer D indicates the lowest editing history data. When the undo operation is performed, the display pointer D is updated so as to indicate the editing history data which is arranged on the next upper layer. When the redo operation is performed after the undo operation is performed, the display pointer D is updated so as to indicate the editing history data which is arranged on the next lower layer.

Next, the case in which a plurality of pages are simultaneously displayed on the page display area 21 of the document editing apparatus 10 will be explained.

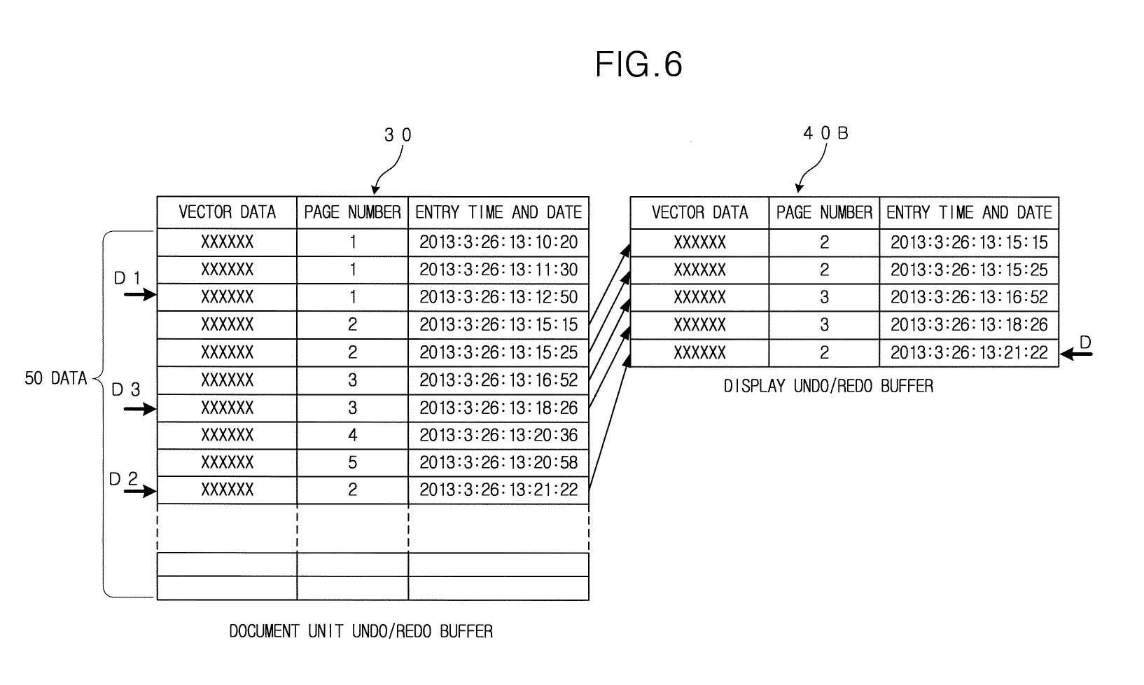

For example, as shown in FIG. 5, in the document editing apparatus 10, two pages can be simultaneously displayed on the page display area 21. When a plurality of pages are simultaneously displayed on the page display area 21 of the document editing apparatus 10, the system control unit 11 (the undo and redo management unit 17) extracts the editing history data for each of a plurality of the displayed pages from the document unit undo/redo buffer 30, and sorts the extracted editing history data in the order of the entry time and date to construct the display undo/redo buffer 40B (See FIG. 6).

For example, in case that the second page and the third page are displayed on the page display area 21, as shown in FIG. 6, the system control unit 11 (the undo and redo management unit 17) extracts only the editing history data having the page number of “2” and the editing history data having the page number of “3”, from the document unit undo/redo buffer 30. By arranging the extracted editing history data in the order of the entry time and date, the system control unit 11 (the undo and redo management unit 17) constructs the display undo/redo buffer 40B corresponding to the case in which the second page and the third page are simultaneously displayed.

Next, the system control unit 11 (the undo and redo management unit 17) selects the editing history data having the newest entry time and date from a plurality of the editing history data indicated by the pointers for the respective displayed pages in the document unit undo/redo buffer 30, and initializes the display pointer D so as to indicate the editing history data in the display undo/redo buffer 40B, which is the same as the above-described editing history data.

In the example of FIG. 6, the entry time and date of the editing history data indicated by the pointer D2 for the second page is newer than that of the editing history data indicated by the pointer D3 for the third page in the document unit undo/redo buffer 30. Therefore, the display pointer D is initialized so as to indicate the editing history data in the display undo/redo buffer 40B, which is the same as the editing history data indicated by the pointer D2 for the second page.

When the instruction to perform the undo operation or the redo operation is received via the undo button 26 or the redo button 27, the document editing apparatus 10 performs the process relating to the undo operation or the redo operation by tracing back the editing history data stored in the display undo/redo buffer 40B which is constructed as described above.

Specifically, when the instruction to perform the undo operation is received, the system control unit 11 (the undo and redo management unit 17) performs the undo operation in accordance with the editing history data indicated by the display pointer D in the display undo/redo buffer 40B, and updates the display pointer D so as to indicate the editing history data having the next older entry time and date.

When the instruction to perform the redo operation is received after the instruction to perform the undo operation is received, the system control unit 11 (the undo and redo management unit 17) performs the redo operation in accordance with the editing history data having the next newer entry time and date than the editing history data indicated by the display pointer D, and updates the display pointer D so as to indicate the above editing history data having the next newer entry time and date.

Further, in case that the handwriting input (additional writing) is received from the user, the system control unit 11 (the undo and redo management unit 17) deletes the editing history data having the entry time and date which is newer than that of the editing history data indicated by the display pointer D, from the display undo/redo buffer 40B. Further, the system control unit 11 (the undo and redo management unit 17) additionally stores the editing history data of the handwriting input in the display undo/redo buffer 40B in the order of the entry time and date, and updates the display pointer D so as to indicate the added editing history data. That is, when the editing operation is performed in any one of the pages displayed on the display unit 15, the system control unit 11 (the undo and redo management unit 17) registers the editing history data of the editing operation in the display undo/redo buffer 40B.

As described above, by performing the undo operation and the redo operation in accordance with the display undo/redo buffer 40B, the undo operation and the redo operation can be performed in a plurality of displayed pages without changing the displayed pages.

In case that the operation for the page turning button 28 is received and the pages displayed on the page display area 21 are changed, or in case that the document is closed and the editing operation is finished, the system control unit 11 (the undo and redo management unit 17) returns the editing history data stored in the display undo/redo buffer 40B to the document unit undo/redo buffer 30 and reconstructs the document unit undo/redo buffer 30. In the reconstruction, all the editing history data are set to arrange the editing history data in the order of the entry time and date in the document unit undo/redo buffer 30. That is, when at least one of the pages displayed on the display unit 15 is not displayed on the display unit 15 by changing one of the pages, the system control unit 11 (the undo and redo management unit 17) reflects the editing history data registered in the display undo/redo buffer 40B on the undo and redo memory (the document unit undo/redo buffer 30) immediately before one of the pages is changed.

Further, in case that the free space of the document unit undo/redo buffer 30 is lack during the reconstruction, that is, in case that when the editing history data stored in the display undo/redo buffer 40B is returned to the document unit undo/redo buffer 30, a total number of the editing history data exceeds the upper limit of the number of times of the undo operation or the redo operation (in this example, 50) in the document unit undo/redo buffer 30, the system control unit 11 (the undo and redo management unit 17) deletes the editing history data in the order from the oldest entry time and date so as for the number of the editing history data stored in the document unit undo/redo buffer 30 not to exceed the above-described upper limit.

Next, the pointer for each of the pages in which the undo operation and the redo operation are managed by the display undo/redo buffer 40B, in the document unit undo/redo buffer 30 is set as described below.

First, the system control unit 11 (the undo and redo management unit 17) specifies the page number of the editing history data indicated by the display pointer D immediately before the reconstruction, and updates the pointer for the page having the specified page number so as to indicate the editing history data in the document unit undo/redo buffer 30, which is the same as the above editing history data indicated by the display pointer D. In case of the editing history data of the editing operation performed in each of the other pages, which are registered in the display undo/redo buffer 40B, the system control unit 11 (the undo and redo management unit 17) selects the editing history data having the entry time and date which is order than that of the editing history data indicated by the display pointer D immediately before the reconstruction and which is the closest to that of the editing history data indicated by the display pointer D immediately before the reconstruction, among the editing history data of the editing operation performed in each page, which are registered in the display undo/redo buffer 40B, and updates each pointer so as to indicate the editing history data in the document unit undo/redo buffer 30, which is the same as the selected editing history data.

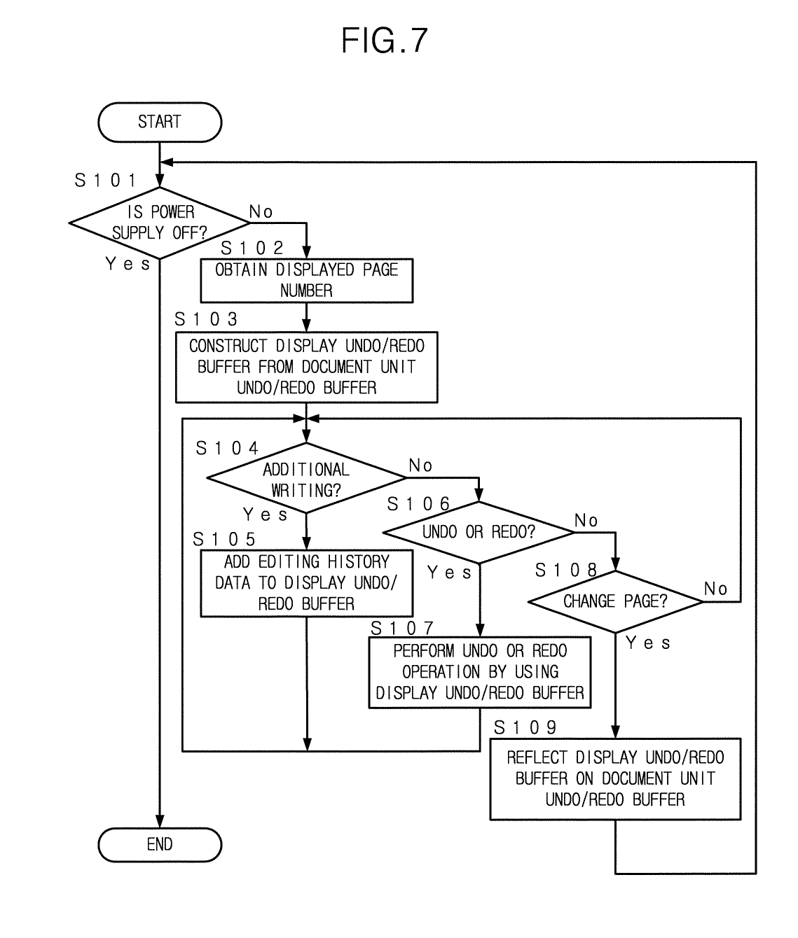

FIG. 7 shows a flowchart of the process relating to the undo operation and the redo operation in the document unit method. By executing the process by the system control unit 11, the above-described operations relating to the undo operation and the redo operation are realized.

In case that the power supply of the document editing apparatus 10 is off (Step S101; Yes), the process is ended. In case that the power supply of the document editing apparatus 10 is not off (Step S101; No), the system control unit 11 obtains the page number of the page which is currently displayed on the page display area 21 of the display unit 15 (Step S102). In case that a plurality of pages are simultaneously displayed, the system control unit 11 obtains each page number of a plurality of the displayed pages.

Next, the system control unit 11 constructs the display undo/redo buffer 40 or 40B from the document unit undo/redo buffer 30 as described above (Step S103).

Thereafter, in case that the additional writing (handwriting input) is received from the user (Step S104; Yes), the system control unit 11 additionally registers the editing history data of the editing operation corresponding to the additional writing in the display undo/redo buffer 40 or 40B (Step S105), and the process returns to Step S104.

In case that the instruction to perform the undo operation or the redo operation is received from the user (Step S106; Yes), the system control unit 11 performs the process (relating to the undo operation or the redo operation) according to the received instruction by using the display undo/redo buffer 40 or 40B (Step S107), and the process returns to Step S104.

In case that the operation for changing the page(s) is received (Step S108; Yes), the system control unit 11 reflects the contents of the display undo/redo buffer 40 or 40B on the document unit undo/redo buffer 30 and reconstructs the document unit undo/redo buffer 30 (Step S109), and the process returns to Step S101.

As described above, without changing one or a plurality of pages which are currently displayed on the page display area 21 of the display unit 15, the undo operation and the redo operation can be performed. Further, because the system control unit 11 manages the upper limit of the number of times of the undo operation and the upper limit of the number of times of the redo operation in units of the document, the undo and redo memory can be effectively used as compared to the case in which the above upper limit is managed in each page separately.

In addition, the display undo/redo buffer 40 or 40B may be constructed in the memory area which is separated from that of the document unit undo/redo buffer 30, or may be virtually constructed by using the document unit undo/redo buffer 30.

That is, the system control unit 11 may perform the undo operation and the redo operation by tracing back only the editing history data of the editing operation performed in the displayed page(s) in accordance with the entry time and date and the page number among the editing history data stored in the document unit undo/redo buffer 30. The display pointer D is set so as to indicate the editing history data in the document unit undo/redo buffer 30, which is the same as the editing history data indicated in the display undo/redo buffer 40 or 40B.

Further, in case that there is no free space of the document unit undo/redo buffer 30 when the additional writing is received, the system control unit 11 deletes the editing history data having the oldest entry time and date in the document unit undo/redo buffer 30, and prepares the necessary space area. When the additional writing is received, the system control unit 11 deletes the editing history data having the page number of the page which is currently displayed and having the entry time and date which is newer than that of the editing history data indicated by the display pointer D, from the document unit undo/redo buffer 30.

At the page changing or the finish of the editing operation, the process for updating the pointer for each page in accordance with the display pointer D, may be performed like the case in which the display undo/redo buffer 40 or 40B is used. However, in case that the document unit undo/redo buffer 30 is always updated during the edit of the document, the process for reflecting the editing history data stored in the display undo/redo buffer 40 or 40B on the document unit undo/redo buffer 30 is not required at the page changing or the finish of the editing operation.

### <Apparatus Unit Method>

In the apparatus unit method, the system control unit 11 (the undo and redo management unit 17) manages the undo/redo buffer which stores all of the editing history data of the document editing apparatus 10. The system control unit 11 (the undo and redo management unit 17) manages the upper limit of the number of the storable editing history data (the undo operation and the redo operation) in units of the undo and redo memory. In this case, instead of the document unit undo/redo buffer 30 used in the document unit method, the system control unit 11 (the undo and redo management unit 17) may use the entire undo and redo memory of the apparatus and further store a document name (a file name) of each document as the editing history data. In case that the display undo/redo buffer 40 or 40B are constructed from the undo and redo memory, the system control unit 11 (the undo and redo management unit 17) may extract the editing history data for the displayed page from the undo and redo memory in accordance with the document name (the file name) and the page number. In the other points, the apparatus unit method may be performed like the document unit method.

### <Page Unit Method>

In the page unit method, the undo/redo buffer (referred to as “page unit undo/redo buffer”) is allocated in units of the page. A part of the undo and redo memory of the document editing apparatus 10 is allocated as the page unit undo/redo buffer for each page.

In case that only one page is displayed on the page display area 21 of the display unit 15, the system control unit 11 (the undo and redo management unit 17) performs the undo operation and the redo operation by using the page unit undo/redo buffer for the displayed page. In case that a plurality of pages are simultaneously displayed on the page display area 21 of the display unit 15, the system control unit 11 (the undo and redo management unit 17) constructs the display undo/redo buffer from the page unit undo/redo buffer for each of a plurality of the displayed pages, and performs the undo operation and the redo operation by using the display undo/redo buffer. Further, the display undo/redo buffer is prepared by using the memory area of the page unit undo/redo buffer for the page which is currently displayed. Further, the display undo/redo buffer may be prepared in another area.

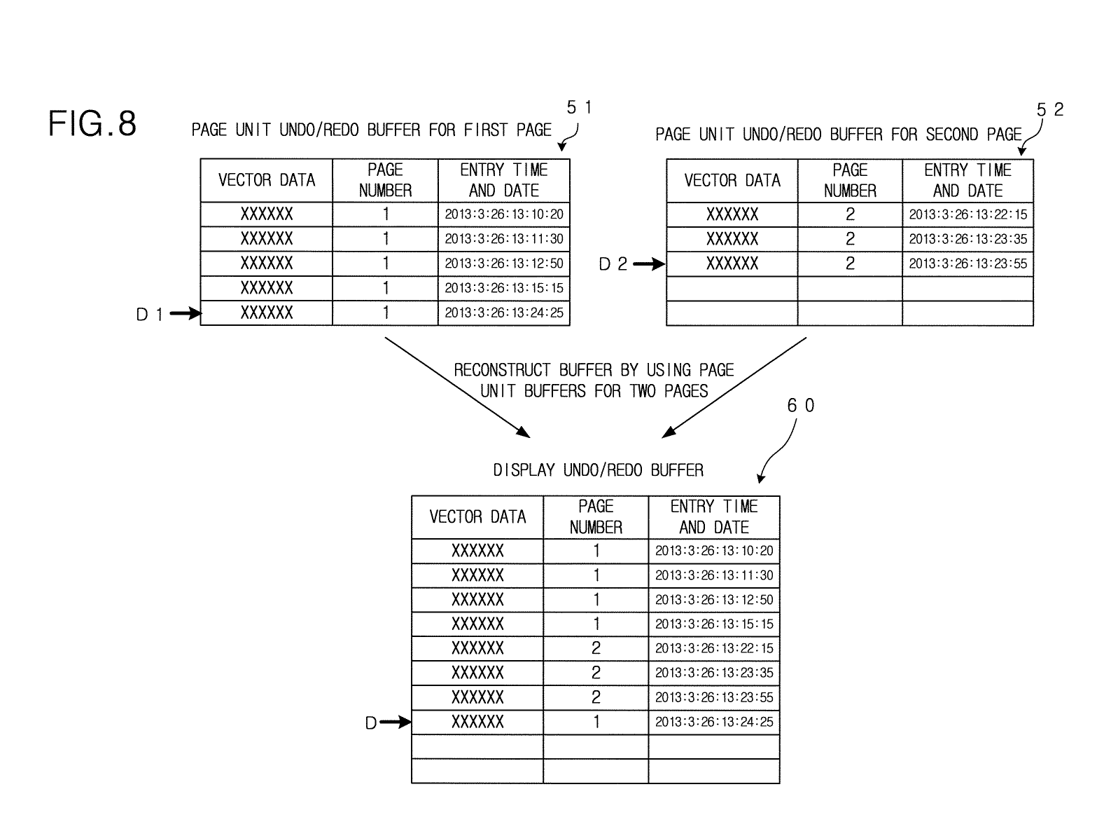

FIG. 8 shows the display undo/redo buffer 60 constructed when the first page and the second page are simultaneously displayed on the page display area 21 of the display unit 15 of the document editing apparatus 10, and the like. In this example, the upper limit of the number of the storable editing history data in one page unit undo/redo buffer is set to 5. Further, the display undo/redo buffer 60 in which the upper limit is 10, is constructed from the page unit undo/redo buffer 51 for the first page and the page unit undo/redo buffer 52 for the second page. That is, in case of a displayed part of the document (in this example, the first page and the second page), the system control unit 11 (the undo and redo management unit 17) manages the upper limit of the number of the storable editing history data (the undo operation and the redo operation) in units of the displayed part of the document. The upper limit set for the display undo/redo buffer 60 may be preferably set within the sum of the upper limit set for the page unit undo/redo buffer 51 for the first page and the upper limit set for the page unit undo/redo buffer 52 for the second page. On the other hand, in case of the page which is not currently displayed on the display unit 15, the system control unit 11 (the undo and redo management unit 17) manages the upper limit of the number of the storable editing history data (the undo operation and the redo operation) in units of the page.

Like the case of the document unit method, the elements of the editing history data include the vector data, the page number and the entry time and date. In the display undo/redo buffer 60, the editing history data is sorted in the order of the entry time and date.

The display pointer D is initialized so as to indicate the editing history data in the display undo/redo buffer 60, which is the same as the editing history data having newer entry time and date between the editing history data indicated by the pointer D1 for the first page and the editing history data indicated by the pointer D2 for the second page.

When the instruction to perform the undo operation or the redo operation is received via the undo button 26 or the redo button 27, the document editing apparatus 10 performs the process relating to the undo operation and the redo operation by tracing back the editing history data stored in the display undo/redo buffer 60 which is constructed as described above.

Specifically, when the instruction to perform the undo operation is received, the system control unit 11 (the undo and redo management unit 17) performs the undo operation in accordance with the editing history data indicated by the display pointer D in the display undo/redo buffer 60. At the same time, the system control unit 11 updates the display pointer D so as to indicate the editing history data having the next order entry time and date.

After the instruction to perform the undo operation is received, when the instruction to perform the redo operation is received, the system control unit 11 (the undo and redo management unit 17) performs the redo operation in accordance with the editing history data having the next newer entry time and date than the editing history data indicated by the display pointer D, and updates the display pointer D so as to indicate the above editing history data having the next newer entry time and date.

Further, in case that the handwriting input (additional writing) is received from the user, the system control unit 11 (the undo and redo management unit 17) deletes the editing history data having the entry time and date which is newer than that of the editing history data indicated by the display pointer D, from the display undo/redo buffer 60. Further, the system control unit 11 (the undo and redo management unit 17) additionally stores the editing history data of the handwriting input in the display undo/redo buffer 60 so as to arrange the editing history data in the order of the entry time and date, and updates the display pointer D so as to indicate the added editing history data.

At this time, in case that the free space of the display undo/redo buffer 60 is lack, that is, in case that the number of the editing history data stored in the display undo/redo buffer 60 reaches the upper limit of the number of the storable editing history data in the display undo/redo buffer 60, the system control unit 11 (the undo and redo management unit 17) deletes the editing history data having the oldest entry time and date among the editing history data stored in the display undo/redo buffer 60, and registers new editing history data therein. Accordingly, the display undo/redo buffer 60 is a ring buffer.

As described above, by performing the undo operation and the redo operation in accordance with the display undo/redo buffer 60, the undo operation and the redo operation can be performed in a plurality of the displayed pages without changing the displayed pages. Further, the upper limit of the number of the storable editing history data for the displayed pages is managed in units of the display undo/redo buffer 60. Therefore, even in case that the additional writing is concentrated on one displayed page, the memory area can be effectively used and the editing history data can be preferentially stored in the order from the editing history data having the new entry time and date. That is, while a plurality of pages are simultaneously displayed, each upper limit set in units of the displayed page is accommodated between a plurality of the displayed pages. Therefore, the editing history data for an arbitrary one page can be stored more than the upper limit set in units of the page.

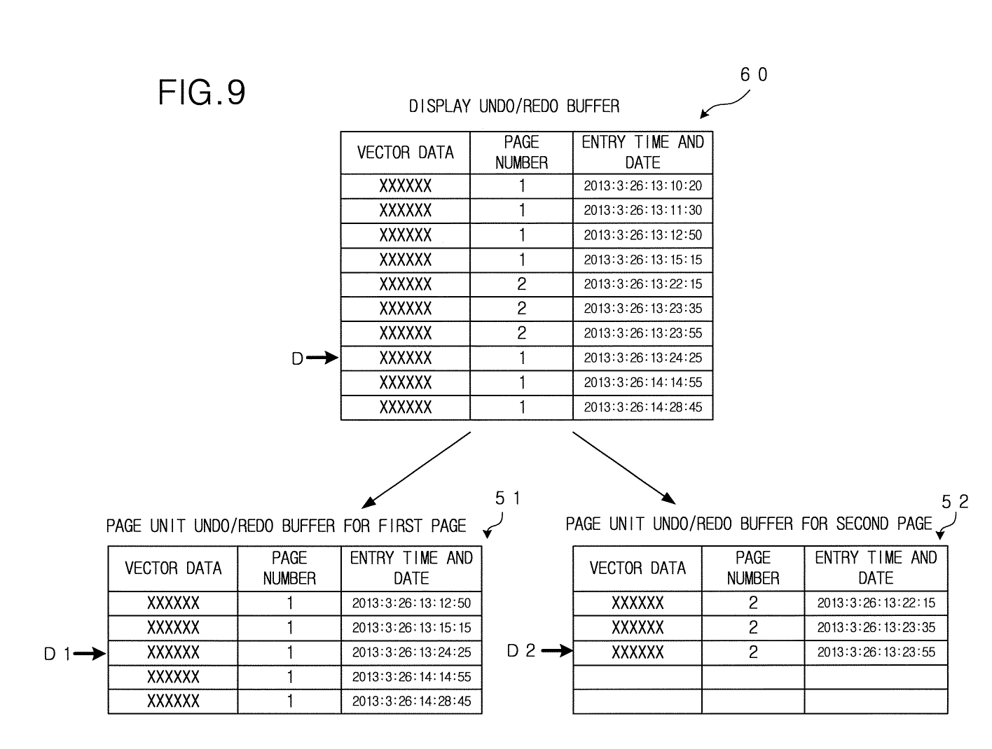

In case that the operation for the page turning button 28 is received and the page displayed on the page display area 21 is changed, or in case that the document is closed and the editing operation is finished, the system control unit 11 (the undo and redo management unit 17) reconstructs the page unit undo/redo buffer 51 for the first page and the page unit undo/redo buffer 52 for the second page from the editing history data stored in the display undo/redo buffer 60, as shown in FIG. 9.

That is, the system control unit 11 (the undo and redo management unit 17) extracts the editing history data for the first page from the display undo/redo buffer 60, and registers the above editing history data in the page unit undo/redo buffer 51 for the first page in the order of the entry time and date. At this time, in case that the number of the extracted editing history data exceeds the upper limit of the number of the storable editing history data in the page unit undo/redo buffer 51 for the first page (in this example, 5), the system control unit 11 (the undo and redo management unit 17) selects the editing history data by the excess of the editing history data over the upper limit in the order from the oldest entry time and date, and deletes the above selected editing history data. That is, when the page displayed on the display unit 15 is not displayed on the display unit 15 by changing the page, in case that the number of the stored editing history data (the undo operation and the redo operation) for the page which is not displayed on the display unit 15 by changing the page exceeds the upper limit of the number of the storable editing history data, which is managed in units of the page, the system control unit 11 (the undo and redo management unit 17) deletes the editing history data by the excess of the editing history data over the upper limit.

Next, the pointer for the first page is set. Specifically, in case that the editing history data which is finally indicated by the display pointer D in the display undo/redo buffer 60 (immediately before the reconstruction) is the editing history data for the first page, the system control unit 11 (the undo and redo management unit 17) sets the pointer D1 for the first page so as to indicate the editing history data in the page unit undo/redo buffer 51 for the first page, which is the same as the editing history data indicated by the display pointer D. In case that the display pointer D finally indicates the editing history data for another page, the system control unit 11 (the undo and redo management unit 17) sets the pointer D1 for the first page so as to indicate the editing history data having the entry time and date which is older than that of the editing history data which is finally indicated by the display pointer D and which is the closest to that of the above editing history data which is finally indicated, among the editing history data for the first page, which are registered in the page unit undo/redo buffer 51 for the first page.

Similarly, the above process is performed for the second page. That is, the system control unit 11 (the undo and redo management unit 17) extracts the editing history data for the second page from the display undo/redo buffer 60, and registers the above extracted editing history data in the page unit undo/redo buffer 52 for the second page in the order of the entry time and date. At this time, in case that the number of the extracted editing history data exceeds the upper limit of the number of the storable editing history data in the page unit undo/redo buffer 52 for the second page (in this example, 5), the system control unit 11 (the undo and redo management unit 17) selects the editing history data by the excess of the editing history data over the upper limit in the order from the oldest entry time and date, and deletes the above selected editing history data.

Next, the pointer for the second page is set. Specifically, in case that the editing history data which is finally indicated by the display pointer D in the display undo/redo buffer 60 is the editing history data for the second page, the system control unit 11 (the undo and redo management unit 17) sets the pointer D2 for the second page so as to indicate the editing history data in the page unit undo/redo buffer 52 for the second page, which is the same as the editing history data indicated by the display pointer D. In case that the display pointer D finally indicates the editing history data for another page, the system control unit 11 (the undo and redo management unit 17) sets the pointer D2 for the second page so as to indicate the editing history data having the entry time and date which is older than that of the editing history data which is finally indicated by the display pointer D and which is the closest to that of the above editing history data which is finally indicated, among the editing history data for the second page, which are registered in the page unit undo/redo buffer 52 for the second page.

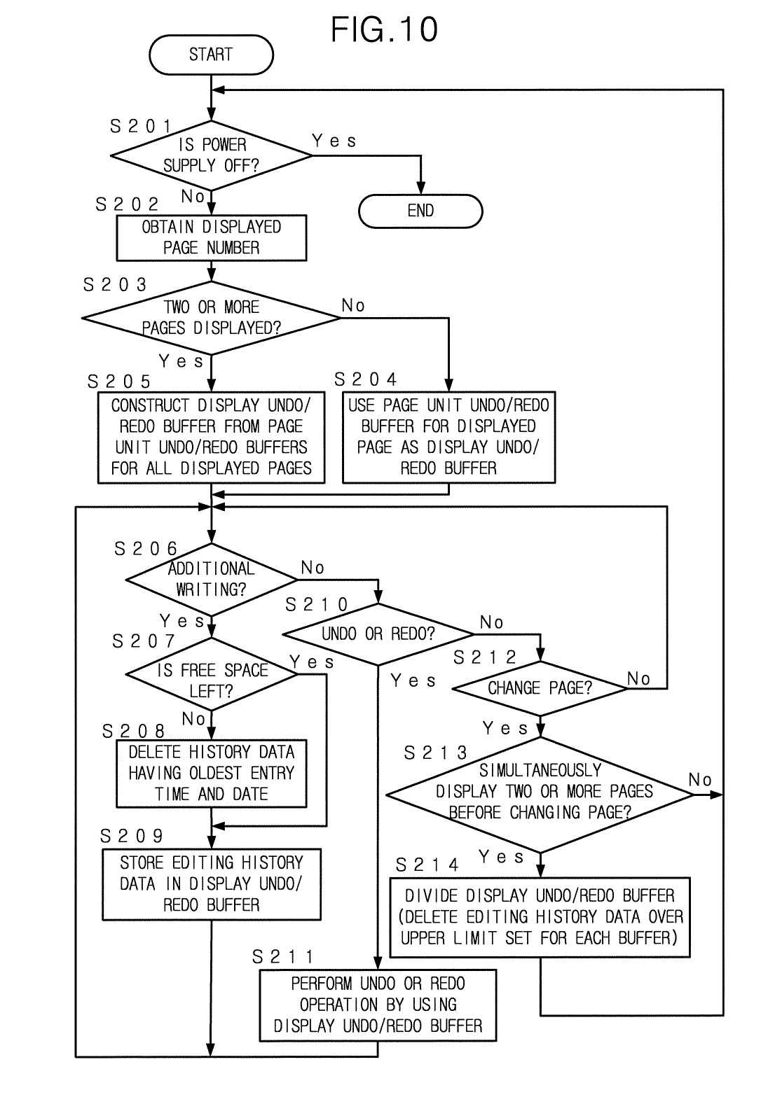

FIG. 10 shows a flowchart of the process relating to the undo operation and the redo operation in the page unit method. By performing this process by the system control unit 11, the operations relating to the undo operation and the redo operation performed in the above-described page unit method are realized.

In case that the power supply of the document editing apparatus 10 is off (Step S201; Yes), the process is ended. In case that the power supply of the document editing apparatus 10 is not off (Step S201; No), the system control unit 11 obtains the page number of the page which is currently displayed on the page display area 21 of the display unit 15 (Step S202). In case that a plurality of pages are simultaneously displayed, the system control unit 11 obtains each page number of a plurality of the displayed pages.

In case that only one page is displayed on the page display area 21 (Step S203; No), the system control unit 11 directly uses the page unit undo/redo buffer and the pointer for the displayed page as the display undo/redo buffer 60 and the display pointer D (Step S204).

In case that a plurality of pages are simultaneously displayed on the page display area 21 (Step S203; Yes), the system control unit 11 constructs the display undo/redo buffer 60 from the page unit undo/redo buffers for the respective displayed pages (Step S205). That is, the system control unit 11 sorts all the editing history data registered in the page unit undo/redo buffers for the respective displayed pages in the order of the entry time and date, and constructs the display undo/redo buffer 60. Further, the system control unit 11 initializes the display pointer D so as to indicate the editing history data in the display undo/redo buffer 60, which is the same as the editing history data having the newest entry time and date among the editing history data indicated by the pointers for the respective pages.

Thereafter, in case that the additional writing (the handwriting input) is received from the user (Step S206; Yes), the system control unit 11 determines whether there is free space of the display undo/redo buffer 60 (Step S207). In case that there is free space of the display undo/redo buffer 60 (Step S207; Yes), the process proceeds to Step 209. In case that there is no free space of the display undo/redo buffer 60 (Step S207; No), the system control unit 11 deletes the editing history data having the oldest entry time and date in the display undo/redo buffer 60 and prepares the space area (Step S208). Then, the process proceeds to Step S209.

In Step S209, the system control unit 11 registers the editing history data corresponding to the additional writing in the display undo/redo buffer 60, and the process returns to Step S206.

In case that the instruction to perform the undo operation or the redo operation is received from the user (Step S210; Yes), the system control unit 11 performs the undo operation or the redo operation by using the display undo/redo buffer 60 (Step S211), and the process returns to Step S206.

In case that the operation for changing the page(s) is received (Step S212; Yes), the system control unit 11 determines whether a plurality of pages are simultaneously displayed before the page(s) is changed (Step S213). In case that only one page is displayed (Step S213; No), the process returns to Step S201.

In case that a plurality of pages are simultaneously displayed before the pages are changed (Step S213; Yes), the system control unit 11 reconstructs the page unit undo/redo buffer for each of a plurality of the displayed pages from the display undo/redo buffer 60, and sets the pointer for each page (Step S214). Thereafter, the process returns to Step S201.

As described above, in the page unit method, in case of the page which is not displayed, the system control unit 11 (the undo and redo management unit 17) manages the upper limit of the number of the storable editing history data in units of the page. In case of the page (s) which is currently displayed, the system control unit 11 (the undo and redo management unit 17) manages the upper limit in units of one or a plurality of the displayed pages. Therefore, in case that a plurality of pages are simultaneously displayed, when the additional writing is concentrated on one page of a plurality of the displayed pages, the editing history data for the page can be stored in the state that the number of the editing history data for the page exceeds the upper limit set in units of the page. The memory area used for the undo operation and the redo operation can be flexibly accommodated. As a result, the memory area can be effectively used as compared to the case in which the upper limit is separately managed for each page.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

In the embodiment, the case in which the editing operation is the handwriting input is explained. However, the editing operation of which the editing history data is stored is not limited to the handwriting input. However, the operation for changing the page is not included in the editing operation of which the editing history data is stored.

In the embodiment, the document editing apparatus 10 which can receive the handwriting input is explained. However, it is not required to have the function of receiving the handwriting input. Further, by instructing the information processing apparatus to execute a predetermined program, the information processing apparatus may operate as the document editing apparatus according to the embodiment.

In the embodiment, the example in which an electronic paper which can maintains the display contents without the power consumption and which consumes the power when the display contents are rewritten is adopted as the display unit 15, is explained. However, the display unit is not limited to the above electronic paper, and a liquid crystal display or the like may be adopted.

One of the objects of the above embodiment is to provide a document editing apparatus, a non-transitory computer-readable recording medium and a document editing method which can continuously perform the undo operation and the redo operation in the page(s) which is currently displayed, without changing the displayed page(s), and which can effectively use the limited undo and redo memory for the undo operation and the redo operation performed in the displayed page(s).

In the above embodiment, the undo operation and the redo operation can be continuously performed in the page(s) which is currently displayed, without changing the displayed page(s). Further, the upper limit of number of times of the undo operation and the upper limit of number of times of the redo operation are managed in units of the document, in units of the displayed part of the document, or in units of the undo and redo memory. Therefore, the undo and redo memory can be used so as to be flexibly accommodated between a plurality of pages, and the memory area can be effectively used. The displayed part of the document indicates a part of the document, which is currently displayed on the display unit. For example, in case that one page of the document is displayed, the displayed part of the document indicates the displayed one page, and in case that a plurality of pages of the document are simultaneously displayed, the displayed part of the document indicates a plurality of the displayed pages.

In the above embodiment, basically, the upper limit of the number of the storable editing history data is managed in units of the page. When a plurality of pages are simultaneously displayed, the upper limit is managed in units of a plurality of displayed pages and the above upper limit is set within the sum of the upper limits set in units of the displayed page. That is, when a plurality of pages are simultaneously displayed, each upper limit set in units of the displayed page is accommodated between a plurality of the displayed pages. Therefore, the editing history data for an arbitrary one page can be stored more than the upper limit set in units of the page.

In the above embodiment, when a plurality of pages are simultaneously displayed, each upper limit set in units of the displayed page is accommodated between a plurality of the displayed pages. Therefore, the editing history data for one page can be stored more than the upper limit set in units of the page. However, when these pages are not displayed, the upper limit is managed in units of the page. Therefore, the editing history data for each page is deleted by the excess of the editing history data over the upper limit set in units of the page.

In the above embodiment, in case that the upper limit is managed in units of the document or the entire undo and redo memory, the display undo/redo buffer is constructed by extracting only the editing history data for the displayed part of the document from the undo and redo memory, and the undo operation and the redo operation are performed by tracing back the editing history data registered in the display undo/redo buffer. As a result, the undo operation and the redo operation can be performed in the displayed page (s) without changing the page(s).

In the above embodiment, for example, in case that the upper limit is managed in units of the document, when the number of the stored editing history data for the document exceeds the upper limit, the editing history data having the old entry time and date among the editing history data for the document is preferentially deleted and the storage area for storing new editing history data is secured.

In the above embodiment, for example, even in case that the undo and redo memory is managed in units of the document, the position of the editing history data to be undone next can be managed in each page.

According to the document editing apparatus, the non-transitory computer-readable recording medium and the document editing method of the embodiment, the undo operation and the redo operation can be continuously performed in the page(s) which is currently displayed, without changing the displayed page (s), and the limited undo and redo memory can be effectively used for the undo operation and the redo operation performed in the displayed page(s).

The present U.S. patent application claims the priority of Japanese Patent Application No. 2013-170525, filed on Aug. 20, 2013, according to the Paris Convention, and the entirety of which is incorporated herein by reference for correction of incorrect translation.

What is claimed is:

1. A document editing apparatus comprising:
a display unit configured to display a part of a document;
a page changing unit configured to change one or more pages displayed on the display unit;
an operating unit configured to receive an editing operation performed in the part displayed on the display unit;
an editing unit configured to edit the part displayed on the display unit in accordance with the editing operation received by the operating unit;
an undo and redo memory configured to store editing history data of the editing operation performed by the editing unit;
an undo and redo instruction unit configured to receive an instruction to perform an undo operation or a redo operation for the editing operation performed by the editing unit;
a memory management unit configured to manage an upper limit of number of storable editing history data including the editing history data of the editing operation performed in the part displayed on the display unit, in units of the document, in units of the part displayed on the display unit or in units of the undo and redo memory; and
an undo and redo performance unit configured to perform the undo operation by tracing back only the editing history data of the editing operation performed in the part displayed on the display unit when the instruction to perform the undo operation is received, among the editing history data stored in the undo and redo memory, in case that the undo and redo instruction unit receives the instruction to perform the undo operation; and configured to perform the redo operation by tracing back only the editing history data of the editing operation performed in the part displayed on the display unit when the instruction to perform the redo operation is received, among the editing history data stored in the undo and redo memory, in case that the undo and redo instruction unit receives the instruction to perform the redo operation.

2. The document editing apparatus of claim 1, wherein in case that the upper limit is managed in units of the displayed part, the memory management unit manages the upper limit of the number of the storable editing history data for a page which is not displayed on the display unit, in units of the page, and the upper limit to be set for the displayed part is set within a sum of the upper limit set for each of one or more pages in the displayed part.

3. The document editing apparatus of claim 2, wherein in case that the upper limit is managed in units of the displayed part, when at least one of the pages displayed on the display unit is not displayed on the display unit by changing at least one of the pages, the memory management unit deletes the editing history data by excess of the editing history data over the upper limit set for the page which is not displayed on the display unit by changing one of the pages,
wherein the excess is caused in case that the number of the stored editing history data for the page which is not displayed on the display unit by changing one of the pages exceeds the upper limit set for the page which is not displayed on the display unit by changing one of the pages.

4. The document editing apparatus of claim 1, wherein
in case that the upper limit is managed in units of the document or in units of the undo and redo memory, the memory management unit extracts only the editing history data of the editing operation performed in the part displayed on the display unit from the undo and redo memory and prepares a display undo/redo buffer for registering the extracted editing history data,
when the editing operation is performed by the editing unit in the part displayed on the display unit, the memory management unit registers the editing history data of the performed editing operation in the display undo/redo buffer,
the undo and redo performance unit performs the undo operation and the redo operation by tracing back the editing history data registered in the display undo/redo buffer, and
when at least one of the pages displayed on the display unit is not displayed on the display unit by changing at least one of the pages, the memory management unit reflects the editing history data registered in the display undo/redo buffer on the undo and redo memory immediately before the page is changed.

5. The document editing apparatus of claim 1, wherein in case that the number of the stored editing history data exceeds the managed upper limit, the memory management unit preferentially deletes the editing history data having old entry time and date.

6. The document editing apparatus of claim 1, wherein the memory management unit indicates the editing history data of the editing operation to be undone in case that a next instruction to perform the undo operation is received, by a pointer for each page.

7. The document editing apparatus of claim 1, wherein the editing operation includes a handwriting input.

8. A non-transitory computer-readable recording medium storing a program, wherein the program causes an information processing apparatus to function as a document editing apparatus comprising:
a display unit configured to display a part of a document;
a page changing unit configured to change one or more pages displayed on the display unit;
an operating unit configured to receive an editing operation performed in the part displayed on the display unit;
an editing unit configured to edit the part displayed on the display unit in accordance with the editing operation received by the operating unit;
an undo and redo memory configured to store editing history data of the editing operation performed by the editing unit;
an undo and redo instruction unit configured to receive an instruction to perform an undo operation or a redo operation for the editing operation performed by the editing unit;
a memory management unit configured to manage an upper limit of number of storable editing history data including the editing history data of the editing operation performed in the part displayed on the display unit, in units of the document, in units of the part displayed on the display unit or in units of the undo and redo memory; and
an undo and redo performance unit configured to perform the undo operation by tracing back only the editing history data of the editing operation performed in the part displayed on the display unit when the instruction to perform the undo operation is received, among the editing history data stored in the undo and redo memory, in case that the undo and redo instruction unit receives the instruction to perform the undo operation; and configured to perform the redo operation by tracing back only the editing history data of the editing operation performed in the part displayed on the display unit when the instruction to perform the redo operation is received, among the editing history data stored in the undo and redo memory, in case that the undo and redo instruction unit receives the instruction to perform the redo operation.

9. The non-transitory computer-readable recording medium of claim 8, wherein in case that the upper limit is managed in units of the displayed part, the memory management unit manages the upper limit of the number of the storable editing history data for a page which is not displayed on the display unit, in units of the page, and the upper limit to be set for the displayed part is set within a sum of the upper limit set for each of one or more pages in the displayed part.

10. The non-transitory computer-readable recording medium of claim 9, wherein in case that the upper limit is managed in units of the displayed part, when at least one of the pages displayed on the display unit is not displayed on the display unit by changing at least one of the pages, the memory management unit deletes the editing history data by excess of the editing history data over the upper limit set for the page which is not displayed on the display unit by changing one of the pages,
wherein the excess is caused in case that the number of the stored editing history data for the page which is not displayed on the display unit by changing one of the pages exceeds the upper limit set for the page which is not displayed on the display unit by changing one of the pages.

11. The non-transitory computer-readable recording medium of claim 8, wherein
in case that the upper limit is managed in units of the document or in units of the undo and redo memory, the memory management unit extracts only the editing history data of the editing operation performed in the part displayed on the display unit from the undo and redo memory and prepares a display undo/redo buffer for registering the extracted editing history data,
when the editing operation is performed by the editing unit in the part displayed on the display unit, the memory management unit registers the editing history data of the performed editing operation in the display undo/redo buffer,
the undo and redo performance unit performs the undo operation and the redo operation by tracing back the editing history data registered in the display undo/redo buffer, and
when at least one of the pages displayed on the display unit is not displayed on the display unit by changing at least one of the pages, the memory management unit reflects the editing history data registered in the display undo/redo buffer on the undo and redo memory immediately before the page is changed.

12. The non-transitory computer-readable recording medium of claim 8, wherein in case that the number of the stored editing history data exceeds the managed upper limit, the memory management unit preferentially deletes the editing history data having old entry time and date.

13. The non-transitory computer-readable recording medium of claim 8, wherein the memory management unit indicates the editing history data of the editing operation to be undone in case that a next instruction to perform the undo operation is received, by a pointer for each page.

14. The non-transitory computer-readable recording medium of claim 8, wherein the editing operation includes a handwriting input.

15. A document editing method comprising:
displaying a part of a document;
changing one or more pages displayed in the displaying;
receiving an editing operation performed in the part displayed in the displaying;
editing the displayed part in accordance with the received editing operation;
storing editing history data of the performed editing operation in an undo and redo memory;
receiving an instruction to perform an undo operation or a redo operation for the performed editing operation;
managing an upper limit of number of storable editing history data including the editing history data of the editing operation performed in the displayed part, in units of the document, in units of the displayed part or in units of the undo and redo memory; and
performing the undo operation by tracing back only the editing history data of the editing operation performed in the part displayed when the instruction to perform the undo operation is received, among the editing history data stored in the undo and redo memory, in case that the instruction to perform the undo operation is received; and performing the redo operation by tracing back only the editing history data of the editing operation performed in the part displayed when the instruction to perform the redo operation is received, among the editing history data stored in the undo and redo memory, in case that the instruction to perform the redo operation is received.

16. The document editing method of claim 15, wherein in case that the upper limit is managed in units of the displayed part, the upper limit of the number of the storable editing history data for a page which is not displayed in the displaying is managed in units of the page, and the upper limit to be set for the displayed part is set within a sum of the upper limit set for each of one or more pages in the displayed part.

17. The document editing method of claim 16, wherein in case that the upper limit is managed in units of the displayed part, when at least one of the pages displayed in the displaying is not displayed by changing at least one of the pages, the editing history data is deleted by excess of the editing history data over the upper limit set for the page which is not displayed by changing one of the pages,
wherein the excess is caused in case that the number of the stored editing history data for the page which is not displayed by changing one of the pages exceeds the upper limit set for the page which is not displayed by changing one of the pages.

18. The document editing method of claim 15, wherein
in case that the upper limit is managed in units of the document or in units of the undo and redo memory, only the editing history data of the editing operation performed in the displayed part is extracted from the undo and redo memory and a display undo/redo buffer for registering the extracted editing history data is prepared,
when the editing operation is performed in the displayed part, the editing history data of the performed editing operation is registered in the display undo/redo buffer,
the undo operation and the redo operation are performed by tracing back the editing history data registered in the display undo/redo buffer, and
when at least one of the pages displayed in the displaying is not displayed by changing at least one of the pages, the editing history data registered in the display undo/redo buffer is reflected on the undo and redo memory immediately before the page is changed.

19. The document editing method of claim 15, wherein in case that the number of the stored editing history data exceeds the managed upper limit, the editing history data having old entry time and date is preferentially deleted.

20. The document editing method of claim 15, wherein the editing history data of the editing operation to be undone in case that a next instruction to perform the undo operation is received, is indicated by a pointer for each page.

21. The document editing method of claim 15, wherein the editing operation includes a handwriting input.
